(19) United States
(12) Patent Application Publication
(10) Pub. No.: US 2005/0276178 A1
(43) Pub. Date: Dec. 15, 2005

(54) Method of deriving suitable-and-hold timing, and optical disk drive using the same method

(76) Inventors: Koichiro Nishimura, Yokohama (JP); Kazuhiro Ikeda, Kawasaki (JP); Toshimitsu Kaku, Sagamihara (JP)

Correspondence Address: MCDERMOTT WILL & EMERY LLP, 600 13TH STREET, N.W., WASHINGTON, DC, 20005-3096, US

(21) Appl. No.: 10/988,837

(22) Filed: Nov. 16, 2004

(30) Foreign Application Priority Data
Jun. 9, 2004 (JP) 2004-170656

(51) Int. Cl. G11B 7/00

(52) U.S. Cl. 369/44.34; 369/44.27; 369/124.01

(57) ABSTRACT

In the sample-and-hold circuit for laser power detection signal and servo signal, the sample-and-hold operation timing is controlled to set by monitoring the output from the sample-and-hold circuit. In the invention of this application, the sample-and-hold timing is changed to be larger or smaller than the estimated timing, and reference is made to the result of the monitoring, thus determining the optimum timing. The sample-and-hold timing is controlled to fix to this optimum value.

### INCORPORATION BY REFERENCE

The present application claims priority from Japanese application JP2004-170656 filed on Jun. 9, 2004, the content of which is hereby incorporated by reference into this application.

### BACKGROUND OF THE INVENTION

The present invention relates to an optical disk drive for writing digital information signals on a disk-like recording medium (CD-R, CD-RW, DVD-R, DVD-RW, DVD-RAM, blue-light disk, and so on).

In the optical disk recording/reproducing apparatus, the laser power control and servo control such as tracking and focusing are stabilized by reception of laser light and performing non-feedback control.

When laser light is received, the light-receiving timing is varied in accordance with the change of power supply voltage to the optical disk drive and with the change of temperature of the drive. A prior art that considers this variation is described in, for example, JP-A-2001-357529. In addition, the effect of this light-receiving timing variation becomes great as the operating speed of the optical disk is increased. Another prior art that takes into account this effect is described in, for example, JP-A-2000-242940.

The state of the recording surface of the optical disk makes a transition with the temperature change during the recording. The transition of the recording surface state will change the reflectivity of light from the optical disk and the light-receiving timing of the reflected light from the optical disk. The change of the light-receiving timing affects the operation of recording the optical disk. Particularly when the optical-disk operating speed is fast, even a very small change of the light-receiving timing will greatly affect the recording operation.

Moreover, since narrow-width NRZ pulse signals frequently occur at the time of recording operation, the change of light-receiving timing during the time when the narrow-width NRZ pulse signals are recorded with high speed will more influence the recording operation.

In the optical recording/reproducing apparatus, since the received laser-light signal is used for the non-feedback control, the change of the light-receiving timing during the recording operation as mentioned above will prevent the laser power control and the servo control such as tracking and focusing control from being appropriately performed.

### SUMMARY OF THE INVENTION

The above problem can be solved by use of an optical disk drive having a laser for emitting laser light to an optical disk so that prescribed data can be recorded on the optical disk, a light-sensitive receiver for receiving the reflected light from the optical disk, first sample-and-hold unit capable of sampling and holding the output signal from the light-sensitive receiver, second sample-and-hold unit capable of sampling and holding the output signal from the first sample-and-hold means, variable timing unit for setting a certain timing selected from a plurality of candidates as the sample-and-hold timing to the first sample-and-hold unit, hold-control unit for updating the sample-and-hold timing to the first or second sample-and-hold unit, and control unit having a function to select a plurality of timings as candidates of the sample-and-hold timing from an arbitrary range of timings and send them to the variable timing unit and a function to send a selected one of the plurality of timings to the hold-control unit. Thus, the reliability of recording information on the optical disk can be enhanced.

### BRIEF DESCRIPTION OF THE DRAWINGS

These and other features, objects and advantages of the present invention will become more apparent from the following description when taken in conjunction with the accompanying drawings wherein:

FIG. 1 is a block diagram of the construction of an embodiment 1.

FIG. 2 is a waveform diagram showing the operating waveforms and timing in the embodiment 1.

FIG. 3 is a graph showing the data captured by an analog-to-digital converter in the embodiment 1 and in an embodiment 2.

FIG. 4 is a graph showing the situation in which computation is made in a learning controller in the embodiments 1 and 2.

FIG. 5 is a block diagram of the construction of the embodiment 2.

FIG. 6 is a diagram showing the situation in which the operating waveforms and timing are estimated in the embodiment 2.

FIG. 7 is a waveform diagram showing the operating waveforms and timing in the embodiment 2.

FIG. 8 is a block diagram of the construction of an embodiment 3.

FIG. 9 is a waveform diagram showing the situation in which the operating waveforms and timing in the embodiment 3 are estimated.

FIG. 10 is a waveform diagram showing the operating waveforms and timing in the embodiment 3.

FIG. 11 is a diagram showing the situation in which the computation in the learning controller in the embodiment 3 is performed.

FIG. 12 is a flowchart showing the first half of the flowchart for the operation of the learning controller in the embodiments 3 and 4.

FIG. 13 is a flowchart showing the second half of the flowchart for the operation of the learning controller in the embodiments 3 and 4.

FIG. 14 is a block diagram of the construction of an embodiment 4.

FIG. 15 is a waveform diagram showing the operating waveforms and timing in the embodiment 4.

FIG. 16 is a diagram showing the situation in which the estimated timing or preset timing value in each embodiment is computed.

FIG. 17 is a block diagram showing an altered part of the construction of the embodiment 4.

### DESCRIPTION OF THE EMBODIMENTS

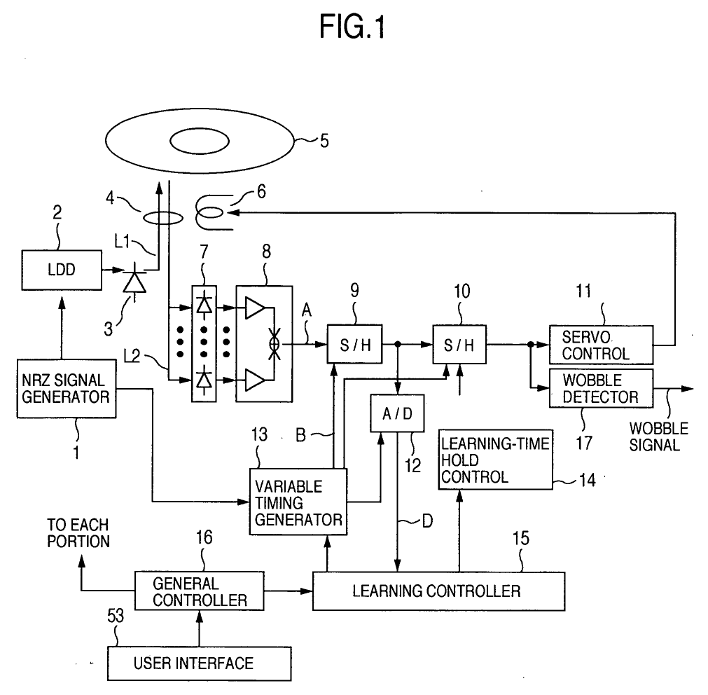

FIG. 1 shows the construction of the optical disk drive of embodiment 1. Referring to FIG. 1, there are shown an NRZ signal generator 1 that encodes recording data by code modulation to produce a recording signal, a laser driver 2 that controls a laser diode to emit light on the basis of the NRZ signal as the recording signal, the laser diode 3 that is driven by the laser driver 2, an object lens 4 that controls light L1 irradiated from the laser diode 3, a recording disk 5, a light-sensitive receiver 7 formed of a plurality of photo acceptance units that receive reflected light L2, and a preamplifier 8 that is formed of the same number of amplifiers as the number of photo acceptance units and that makes an adequate arithmetic operation on this amplified received light-based electric signal. In addition, there are shown a sample-and-hold device 9 that samples and holds an output signal A produced from the preamplifier 8, a servo control 11 that servo controls on the basis of the sample-and-hold result, an actuator coil 6 that is driven by the servo control 11, a variable timing generator 13 that generates each timing signal when a specified width pulse of the NRZ signal comes, an analog-to-digital converter (A/D) 12, another sample-and-hold device 10, a learning-time hold controller 14 that controls the sample-and-hold device 10, a learning controller 15 that controls the learning operation, a general controller 16 that controls the whole drive, a wobble detector 17 that detects a wobble signal, and a user interface 53.

The servo circuit arrangement of the optical disk drive in this embodiment is of the system in which the electric signal resulting from receiving the reflected light is sampled and held to produce an error signal when the NRZ signal is recorded. This servo circuit arrangement makes servo control for focus and tracking, and detects wobbles.

Now, let us explain a method for correcting the timing to be optimum at the time of trial writing when a default sample-and-hold timing (hereinafter, called the preset timing value) under a predetermined recording speed, or operating speed deviates from the optimum timing because of individual difference, temperature change, change with time and so on.

The optical disk drive of this embodiment can make two operations, or normal operation and learning operation. The normal operation is further divided into the recording operation and reading operation. The general controller 16 controls one of these operations to be selected.

At the time of recording of the normal operation, the variable timing generator 13 generates a sample-and-hold timing signal B so that predetermined recording NRZ signal pulses can keep a constant phase. Here, it is assumed that the predetermined recording NRZ signal pulses are the pulses of 4 T in pulse width that appear at a high frequency when these pulses are recorded according to the DVD standards.

At this time, the sample-and-hold device 9 is controlled to hold the preamplifier-output signal according to predetermined timing, and the sample-and-hold device 10 is configured for through outputting. In other words, the output from the sample-and-hold device 9 is supplied to the servo control 11 and wobble detector 17. During this operation, the learning controller 15 takes a pause.

At the time of reading of the normal operation, the sample-and-hold devices 9 and 10 are controlled to through output. In other words, the output itself from the preamplifier 8 is supplied directly to the servo control 11 and wobble detector 17.

In the learning operation, in order to start the recording operation, the general controller 16, at the trial writing time, collects recording conditions such as recording speed and media to be recorded. At this time, the learning controller 15 is actuated to start the learning operation. During the learning operation, since the sample-and-hold device 9 receives a plurality of timing signals as sample-and-hold timings, the output from the sample-and-hold device 9 is disturbed. Therefore, at the start of the learning operation, the sample-and-hold device 10 holds the preamplifier-output signal value sampled and held at a preset timing value by the sample-and-hold device 9 and supplies it to the servo control 11 and so on. In other words, the signal held by the sample-and-hold device 10 is supplied to the servo control 11 and wobble detector 17.

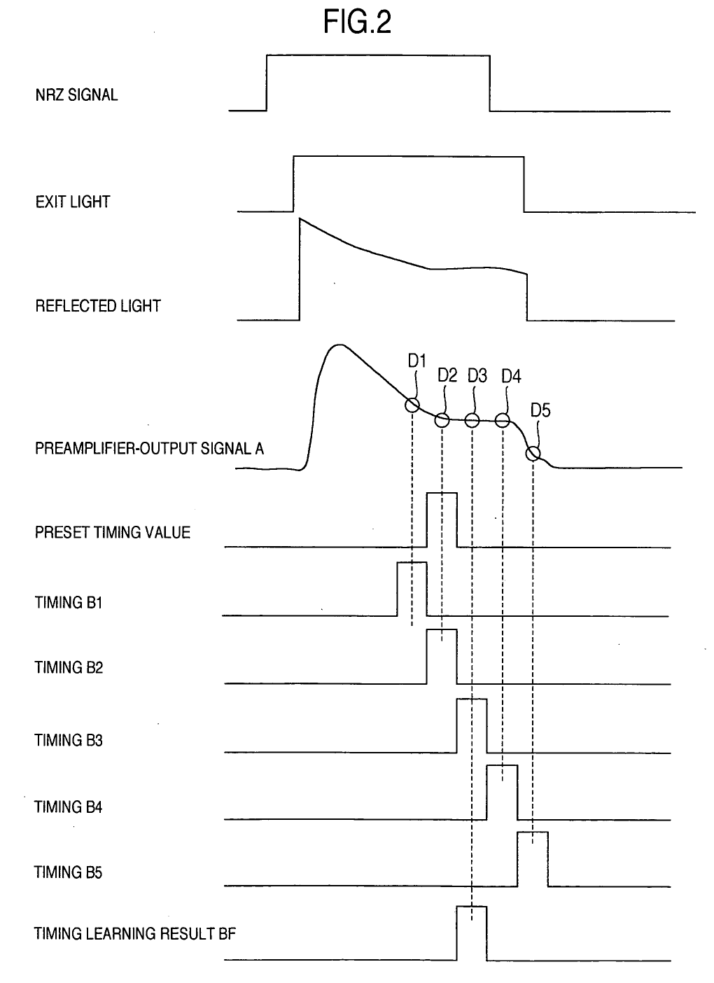

The learning operation will be described in detail with reference to FIGS. 2, 3 and 4.

First, the sample-and-hold timing about the reflected light will be mentioned with reference to FIG. 2. In FIG. 2, it is assumed that the sample-and-hold device 9 makes sampling operation when the timing signal B is of high level and holding operation when it is of low level.

Next, a method of setting sample-and-hold timings B1 through B5 will be mentioned.

First, the learning controller 15 sends a default preset timing value to the variable timing generator 13 and learning-time hold controller 14. The variable timing generator 13 sets the timings B₁ through B₅ including the preset timing value as the sample-and-hold timings on the basis of this preset timing value. Here, it is assumed that the range of the timings B₁ through B₅ including the preset timing value has a width of 1 T in this embodiment.

Secondly, the variable timing generator 13 generates the timing B₁ as a sample-and-hold timing. The result of sampling and holding the preamplifier output signal A at the timing instant B₁ is converted to a digital value by the analog-to-digital converter (A/D) 12. The learning controller 15 receives this digital value as D₁.

Similarly, the variable timing generator 13 generates B₂ through B₅ as a sample-and-hold timing in turn, and the learning controller 15 receives the results (D₂ through D₅) of sampling and holding at the respective timings. Since this embodiment makes a single sample-and-hold operation each time the NRZ signal is recorded, all the sample-and-hold results at timings B₁ through B₅ are completely obtained after the NRZ signal is recorded five times.

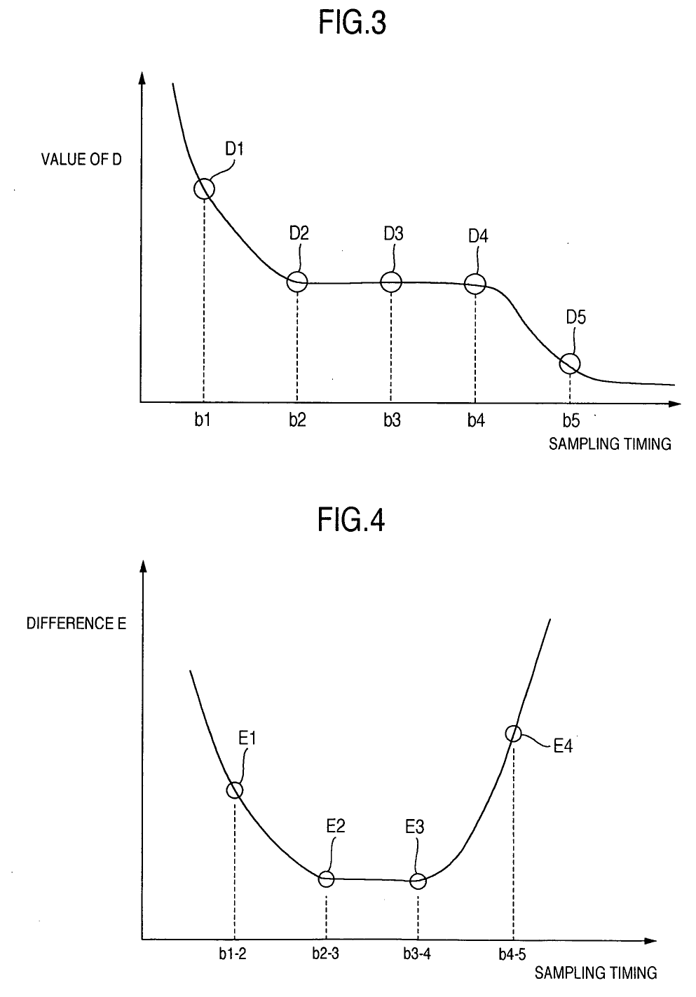

FIG. 3 shows the digital values D₁ through D₅ that the learning controller 15 has taken in. In this case, a threshold may be used to judge the digital values as ones corresponding to the time of recording the NRZ signal and select those from the taken-in digital values. The learning controller 15 computes the following equation (1) by substituting the values of D₁ through D₅ into the equation (1) to obtain differences E₁ through E₄ as shown in FIG. 4.
Eₙ=|Dₙ−D₍ₙ₊₁₎| (1)

From FIG. 4, it will be understood that the difference E of E₂ or E₃ becomes the minimum. This means that the waveform of the preamplifier output signal A at the timings B₂ through B₄ corresponding to E₂ and E₃ is flat or a gentle slope. In other words, this means that, if the signal obtained at these timings is used for servo control, the servo control can be performed on the basis of the stable part of the preamplifier output signal A without using the large-change part.

Thus, the learning controller 15 selects any ones of the timings B₂ through B₄ corresponding to the minimum difference E of the difference E₂ or E₃ as candidates for the optimum timing. In addition, it eliminates, from these candidates, ones around which the difference E abruptly changes. In other words, it excludes the timings B₂ and B₄ corresponding to the abruptly changing difference E₁ or E₄. Thus, since the timing B₃ is left, this timing is selected as a learning result B_{f}. If plural candidates are still left after the above processing, the intermediate timing of the candidates may be selected.

Subsequently, the learning controller 15 sets the learning result B_{f} (=B₃) in the variable timing generator 13, and the variable timing generator 13 sets the learning result in the sample-and-hold timing to the sample-and-hold device 9 or 10. If the learning result is set in the sample-and-hold timing to the sample-and-hold device 9, the hold controller 14 makes the sample-and-hold device 10 through output. If the learning result is set in the sample-and-hold timing to the sample-and-hold device 10, the variable timing generator 13 makes the sample-and-hold device 9 through output. Thus, the general controller 16 is directed to indicate the learning result B_{f} and end and to change the drive operation from the learning operation to the normal operation.

This embodiment as described above, during the trial writing, performs this timing learning operation, thereby keeping paces with changes of the timing away from the optimum due to individual difference, temperature change and change with time if the preset timing value is known for the operating speed. However, even if the preset timing value is unknown for the operating speed, the learning operation can be performed during the trial writing by use of the construction of this embodiment, thus making it possible to cope with the change of the timing away from the optimum due to the individual difference, temperature difference and change with time. Here, the operating speed for which the optimum timing is not completely set in advance implies the intermediate speed between the two previously set operating speeds or a faster speed out of the range of the previously set operating speed. When the angular speed is made constant, the linear velocity along the outer periphery of the optical disk is about 2.5 times faster than that along the inner periphery. In addition, when the normal writing operation is made on the optical disk, the ambient temperature of the pickup assembly (including the laser, object lens and photo acceptance units) is increased 20˜30 degrees. The change of the operating speed and the change of the ambient temperature of the pickup assembly will vary the preamplifier output waveform. Thus, the stable preamplifier output cannot be sampled and held under only the same sample-and-hold timing without the timing learning operation. Even in this situation, if this timing learning operation is performed, the preamplifier output can be sampled and held within a small-variation region.

Moreover, the learning operation is not only performed in a concentrated manner within a short time period, but also may be made in a time-division manner. This is carried out as follows. Switching is instantaneously made from the normal operation to the learning operation in which the timing B₁, for instance, is selected to obtain D₁, and then switching is made back to the normal operation. A constant time after, switching is momentarily made from the normal operation to the learning operation in which the timing B₂ is selected to obtain D₂, and then back to the normal operation. Thus, D₁ through D₄ can be obtained by repeating these operations, and then the optimum timing is set by computing. In this case, there is the effect that the learning operation can be carried out with a small influence on the servo operation while the user data is actually being recorded.

Therefore, the learning operation can be performed not only during the trial writing, but also during the actual operation in regular intervals or irregular intervals. Since the actual operating time for DVD recording sometimes exceeds 2 hours, the temperature and power supply voltage change during the actual operation, and the optimum timing also changes in connection therewith. If the learning operation is periodically performed during the actual operation, it is possible to cope with the change of the operating speed of each portion due to the temperature change and supply voltage change without stopping the actual operation.

Also, it is possible to continuously change the operating speed during the actual operation, and perform the learning operation at each operating speed. This is because the learning operation can be made for the intermediate speed and faster speed at which the preset timing value is not fixed according to the construction of this embodiment.

The effects achieved by the learning method of this embodiment will be given as follows.
(1) When the preset timing value for the operating speed is already known before the trial writing, the learning operation can be made on the basis of the preset timing value at the time of trial writing so that the optimum timing can be obtained without the influence of the individual difference of the recording media, temperature change and change with time.
(2) Under the intermediate operating speed of the two different operating speeds for which the preset timing values are known, the optimum timing can be obtained without the influence of the individual difference of the recording media, temperature change and change with time by the learning operation during the trial writing even if the preset timing value for this intermediate operating speed is unknown.
(3) When the disk is rotated at a faster speed than the two different operating speeds for which the preset timing values are known, the optimum timing can be obtained without the influence of the individual difference of the recording media, temperature change and change with time by the learning operation during the trial writing even if the preset timing value for this faster operating speed is unknown.
(4) When the preset timing value for the operating speed is known at the time of trial writing, the learning operation for the optimum timing can be repeatedly performed during the actual operation at regular intervals or irregular intervals to cope with the deviation from the optimum timing due to the changes of temperature and power supply voltage during the actual operation.
(5) When the preset timing value for the operating speed is known at the time of trial writing, the learning operation for the optimum timing, even if the preset timing value is continuously changed to one for an unknown operating speed, can be repeatedly performed during the actual operation at regular intervals or irregular intervals to cope with the deviation from the optimum timing due to the changes of temperature and power supply voltage during the actual operation.

In addition to the above effects (1) through (5), the effects obtained by the construction of this embodiment shown in FIG. 1 can be summarized as below.

In the construction of this embodiment, the variable timing generator 13 is able to change the sample-and-hold timing.

In the construction of this embodiment, the influence on the servo control and wobble detection can be reduced even during the learning operation by holding the output from the sample-and-hold device 10 during the learning operation.

In the construction of this embodiment, since the sampling and holding operation is performed once each time the NRZ signal is recorded, the sample-and-hold devices 9 and 10 and the analog-to-digital converter 12 may be low-speed ones. Therefore, there is the merit of relatively low cost and low consumption power.

The servo control 11 in this embodiment makes focus control and tracking control. In this case, since the focus control and tracking control need two different preamplifier output signals obtained after the amplification and computation of the received light-based electric signal because the focus control and tracking control employ different signals resulting from computing on the received light-based electric signal according to different computation methods. In addition, although the servo control 11 and wobble detector 17 shares the same output from the sample-and-hold device 10 in this embodiment, they might use separate output signals, respectively. In other words, in addition to the preamplifier output signal for the focus control and tracking control, another preamplifier output signal may be provided for the wobble detection. The same method of computing on the received light-based electric signal may be used in the tracking control and wobble detection.

In this case, it is necessary to provide a plurality of state detectors. In order to deal with this, the sample-and-hold devices 9 and 10 and variable timing generator 13 are provided for each of different preamplifier-output signals, and a switch is added to use when the respective preamplifier output signals are sequentially fed to the analog-to-digital converter 12 so that the analog-to-digital converter 12 and learning controller 15 can be shared by those signals.

In addition, since the three different preamplifier-output signals for the focus control, tracking control and wobble detection occur at substantially the same time, the sample-and-hold timings to the sample-and-hold devices that respectively sample and hold the three different preamplifier-output signals may be the same.

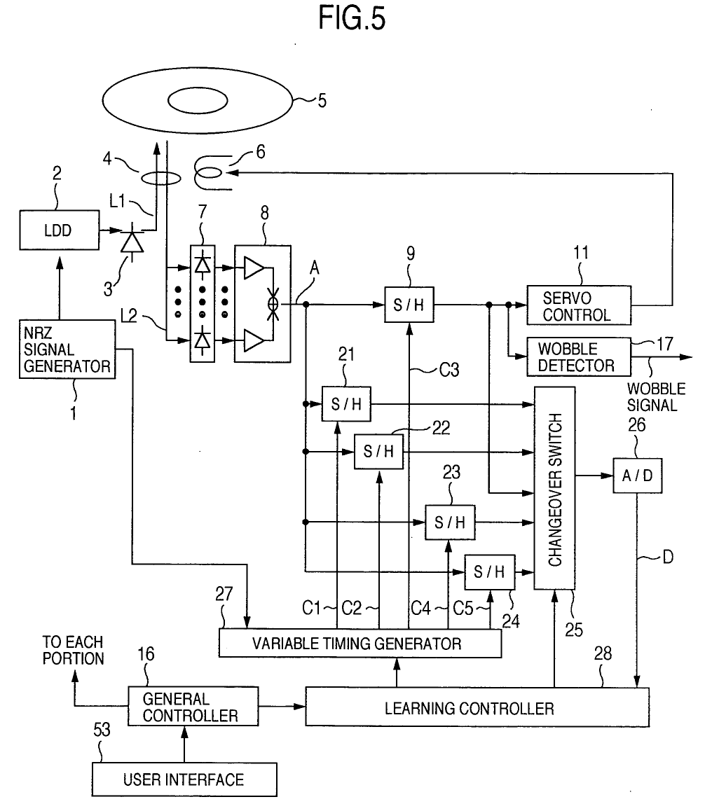

FIG. 5 shows the construction of the optical disk drive of an embodiment 2. In FIG. 5, like elements corresponding to those in the optical disk drive of the embodiment 1 are identified by the same reference numerals, and will not be described. The optical disk drive of this embodiment 2, differently from the embodiment 1, has a variable timing generator 27, sample-and-hold devices 21 through 24 arranged in parallel with the sample-and-hold device 9, a change-over switch 25, an analog-to-digital converter 26, and a learning controller 28.

The sample-and-hold devices 21 through 24 are connected in parallel in order to sample and hold the preamplifier-output signal A in the same way as does the sample-and-hold device 9. Also, while four sample-and-hold devices are connected in parallel with the sample-and-hold device 9 in this embodiment, an arbitrary number of sample-and-hold devices may be provided.

In this optical disk drive, preset timing values are previously selected for the first operating speed (speed 1) and second operating speed (speed 2), respectively. If any timing value is not preset for the intermediate operating speed (speed 1.5), a timing-learning operation is carried out at the trial writing time. An example of this operation will be described below.

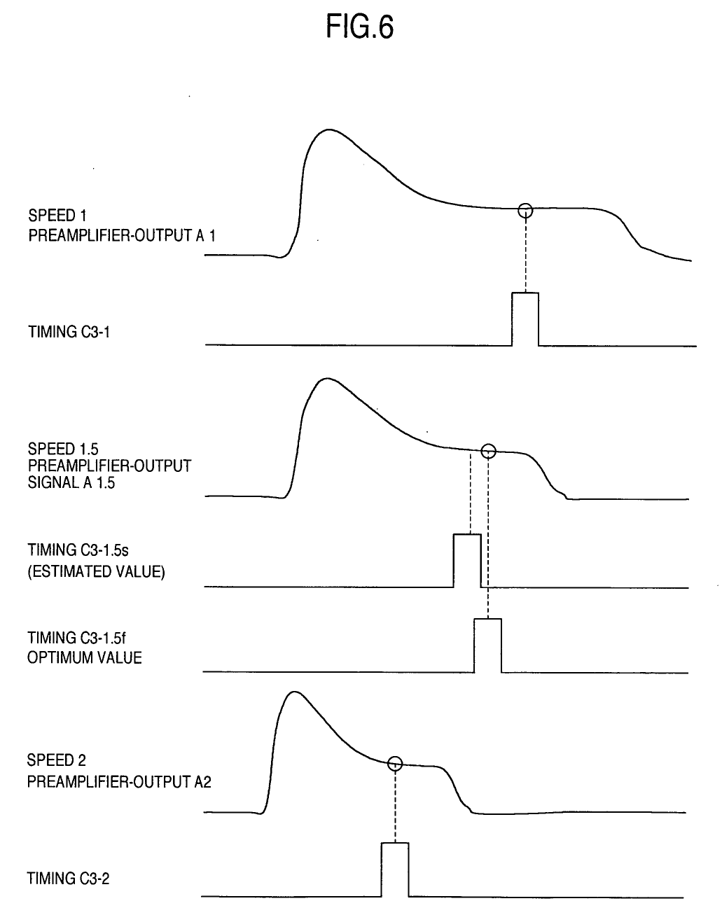

FIG. 6 shows preset timing values of C3-1 for speed 1 and C3-2 for speed 2, an estimated timing C3-1.5S for speed 1.5, and a true optimum timing C3-1.5f for speed 1.5. Here, it is assumed that the estimated timing C3-1.5S computed by the linear interpolation of the timing C3-1 for speed 1 and the timing C3-2 for speed 2 is different from the true optimum timing C3-1.5f.

The processes for the learning operation will be sequentially described with reference to FIG. 5.

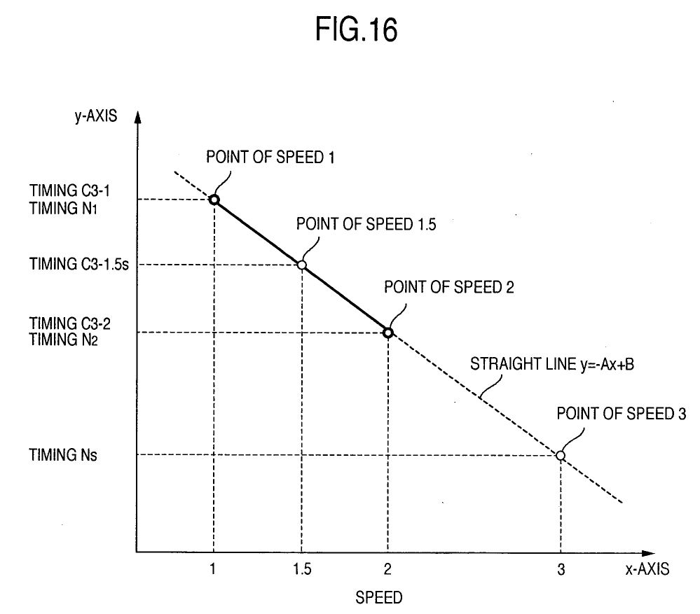

First, the general controller 16 controls the operating speed of each portion to be set for the operating speed 1.5, and the trial writing to be started. Then, the general controller 16 actuates the learning controller 28 to make learning operation. The learning controller 28 checks if the preset timing value for speed 1.5 is previously set, and recognizes that the preset timing value is not set. Thus, it makes the linear interpolation for the estimation of timing. The computation for this estimation will be described with reference to FIG. 16. In FIG. 16, the x-axis indicates the speed, and y-axis the timing value expressed in a form of delay time from the NRZ signal pulse. Here, the preset timing values for speed 1 and speed 2 are plotted, and these two points are connected by a straight line. This straight line can be expressed by the following equation (2). Since the speed 1.5 is intermediate between the speeds 1 and 2, the estimated timing C3-1.5s can be calculated as a point on this straight line.
y=−Ax+B (2)

The learning controller 28 supplies the estimated timing C3-1.5s to the variable timing generator 27. The variable timing generator 27 is configured to generate and supply the estimated timing C3-1.5s as a sample-and-hold timing C3 to the sample-and-hold device 9 in order that a main line signal can be obtained. Here, the main-line signal is the signal that is produced when the sample-and-hold device 9 samples and holds the preamplifier-output signal A fed from the preamplifier 8 in order that it can be used in the servo control 11 and wobble detector 17. Thus, a tentative operating precision can be assured by using the estimated timing C3-1.5s although the optimum timing is not obtained yet.

Then, the learning controller 28 confirms that the sample-and-hold timing C3-1.5s is set in the variable timing generator 27, and then fixes the NRZ pulse width to a value as the target for making the learning about the timing. Here, it is assumed that the NRZ pulse width is 4 T, or the same as in the embodiment 1.

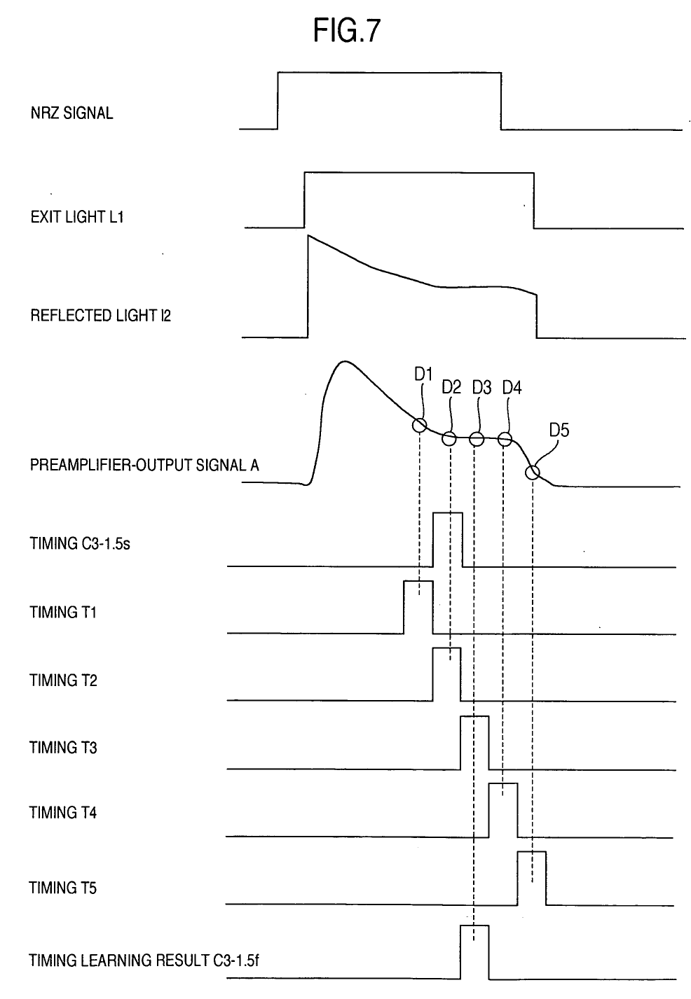

The learning controller 28 also sets timings T₁ through T₅ including the estimated timing C3-1.5s as sample-and-hold timings as shown in FIG. 7.

The variable timing generator 27, when detecting the NRZ recording pulse of 4-T width, once produces timing pulses T₁ through T₅ at sample-and-hold timing pulse terminals C1 through C5 at a time. Thus, each of the sample-and-hold devices 21 through 24 and 9 makes their sample-and-hold operation once. In other words, the sample-and-hold devices hold five different sampled values corresponding to the timings T₁ through T₅, respectively.

The changeover switch 25 sequentially selects one of the values held in the sample-and-hold devices 21 through 24 and 9 and supplies the selected value to the analog-to-digital converter 26, where it is converted to a digital value (D₁ through D₅). The digital values D₁ through D₅ are sequentially fed to the learning controller 28 as digital values sampled at the timings T₁ through T₅.

Here, although how to find the optimum timing in this embodiment is the same as that described with reference to FIGS. 3 and 4 of embodiment 1, and thus will not be described, the true optimum timing T₃ can be obtained according to this embodiment.

Thereafter, the learning controller 28 sets the learning result T₃ (=C3-1.5f) in the C3 output of the variable timing generator 27, and the general controller 16 is directed to indicate the learning result and end and to change the operation mode from the learning operation to the normal operation.

While the estimated timing C3-1.5s is set in the sample-and-hold timing to the sample-and-hold device 9 in this embodiment, an arbitrary timing may be set.

According to this embodiment, as described above, if the operating speed is intermediate between the two different operating speeds for which the preset timing values are known, the timing learning operation is performed during the trial writing operation to obtain the optimum timing without the influence of the individual difference of the recording media, temperature change and change with time. Even when the learning method of this embodiment is used, it is also possible to achieve the same effects (1) through (5) as in the embodiment 1.

In addition, the effects obtained by the construction of this embodiment shown in FIG. 5 can be summarized as follows.

The construction of this embodiment can achieve the particular effect that sample-and-hold operations can be simultaneously made at a plurality of timing values when the NRZ signal is recorded once. This effect cannot be obtained by the construction of the embodiment 1.

In the construction of this embodiment, since the sample-and-hold timing to the sample-and-hold device 9 that produces the main-line signal is not necessary to change, the learning operation can be performed without influence on the servo control and wobble detection. Therefore, the normal servo control and wobble detection can be continued even during the learning control.

In the construction of this embodiment, each of the changeover switch 25 and analog-to-digital converter 26 may be a low-speed device. This is because the construction of this embodiment causes the sample-and-hold devices to sample and hold at a plurality of timings when the NRZ signal is recorded once, and then forces the analog-to-digital converter to sequentially receive the held values one by one. Therefore, there is the merit of relatively low cost and low consumption power.

The servo control 11 in this embodiment performs focus control and tracking control. At this time, since the focus control and the tracking control respectively employ different methods for the computation on the received light-based electric signal, two different preamplifier-output signals are required to produce after the amplification of and computation on the received light-based electric signal. While the servo control 11 and wobble detector 17 share the same output from the sample-and-hold device 10 in this embodiment, they may use separate values. That is, in addition to the preamplifier-output signal for the focus control and tracking control, another preamplifier-output signal may be provided for the wobble detection. Also, the same method for computation on the received light-based electric signal may be used for the tracking control and wobble detection.

In this case, it is necessary to provide a plurality of state detectors. For this purpose, the sample-and-hold device 9 is provided for each of the preamplifier-output signals, and a changeover switch is added that is used when the respective preamplifier-output signals are fed to the sample-and-hold devices 21 through 24 so that they can share the sample-and-hold devices 21 through 24, changeover switch 25, analog-to-digital converter 26, variable timing generator 27 and learning controller 28.

In addition, since the three different preamplifier-output signals for the focus control, tracking control and wobble detection are produced at substantially the same time, the sample-and-hold timings at which the sample-and-hold devices sample and hold those preamplifier-output signals may be the same.

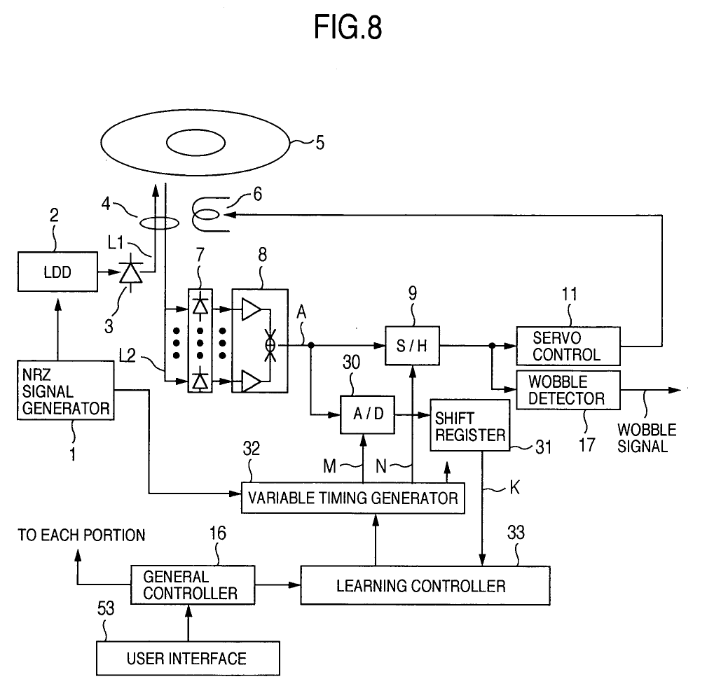

FIG. 8 shows the construction of the optical disk drive of an embodiment 3. In FIG. 8, like elements corresponding to those in the optical disk drive of embodiment 1 are identified by the same reference numerals, and will not be described. The optical disk drive of this embodiment has newly an analog-to-digital converter 30, a shift register 31, a variable timing generator 32, and a learning controller 33.

Description will be made of a method of making the timing learning operation for the optimum high-precision timing in this optical disk drive by using a simpler circuit arrangement than the learning method used in the optical disk drive of embodiment 1 or 2.

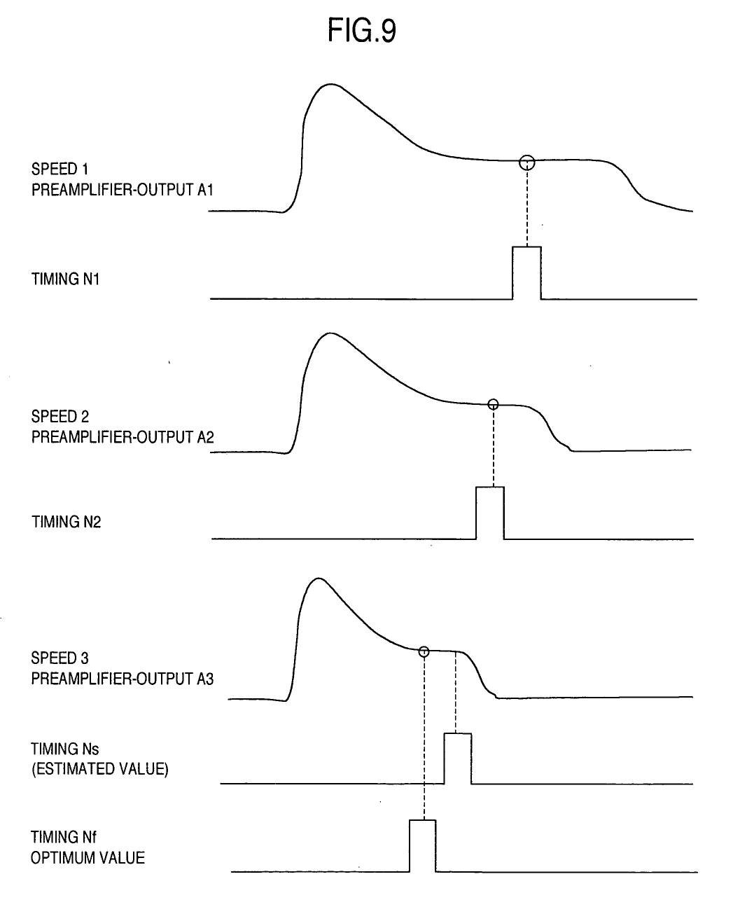

FIG. 9 shows the relation of a preamplifier-output signal A1 for the first operating speed (speed 1) for which a preset timing value N₁ is previously set or found by learning, a preamplifier-output signal A2 for the second operating speed (speed 2) for which a preset timing value N₂ is previously set or required to set by learning, and a preamplifier-output signal A3 for the speed 3 for which any preset timing value is not known, or for which an estimated timing Nₛ and an optimum timing N_{f} will be set. Here, it is assumed that the estimated timing Nₛ is calculated by substituting the speed 3 into the linear expression that is derived by substituting the speeds 1 and 2 and N₁ and N₂ into the equation (2). In this embodiment, it is assumed that the estimated timing Nₛ is different from the true optimum timing N_{f}.

The operations will be sequentially mentioned with reference to FIGS. 8, 12 and 13. First, the general controller 16 is directed to set the operating speed of each portion for operating speed 3 and to start the trial writing operation. Then, it actuates the learning controller 33 in order to perform the learning operation.

First, the learning controller 33 checks if a preset timing value for speed 3 is previously set (S1202), and recognizes that a default preset timing value for the speed is not set yet (S1203). In this case, the estimated timing Nₛ is calculated by using the optimum timings N₁ and N₂ for the neighboring speeds 1 and 2 (S1205, S1206). The learning controller 33 supplies the estimated timing Nₛ to the variable timing generator 32. The variable timing generator 32 is configured to generate the estimated timing Nₛ as the sample-and-hold timing to the sample-and-hold device 9 so that the main line signal can be produced from the device. Thus, a tentative operating precision can be assured by using the estimated timing Nₛ although it is not the optimum timing.

Then, the learning controller 33 confirms that the sample-and-hold timing Nₛ is set in the variable timing generator 32, and then sets the NRZ pulse-width as the target for making the learning (S1207). Here, it is assumed that the NRZ pulse-width is 4 T, or the same as in the embodiment 1 or 2.

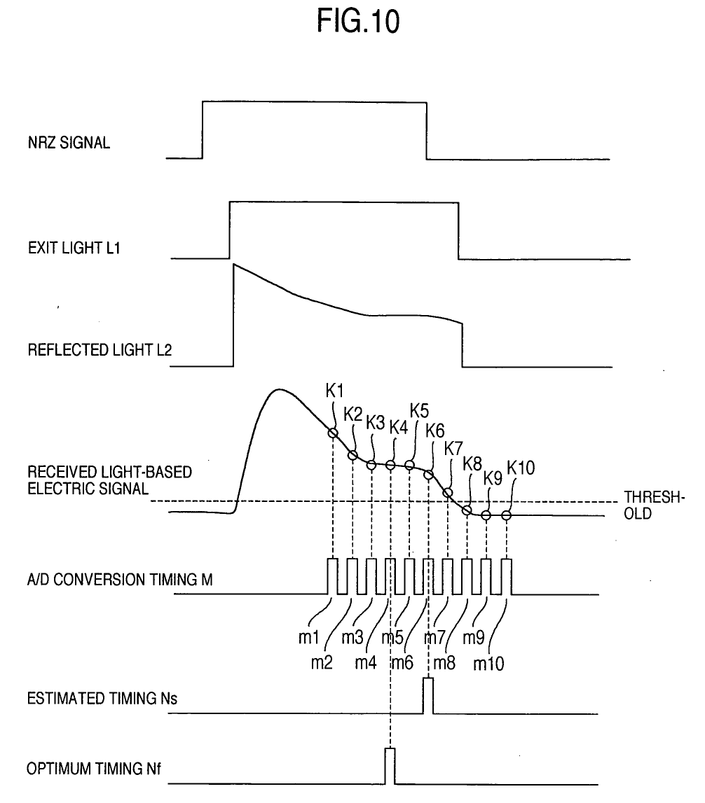

The learning controller 33 also sets timings m₁ through m₁₀ including the estimated timing Ns in the variable timing generator 32 as the sample-and-hold timings as shown in FIG. 10 (S1207).

The variable timing generator 32, when detecting the NRZ recording pulse of 4-T width, generates timing pulses at the timings m₁ through m₁₀ so that the analog-to-digital (A/D) converter 30 makes the analog/digital conversion at those pulses along timing M. The analog-to-digital converter 30 converts the preamplifier-output signal A at each of the pulses m₁ through m₁₀ to produce a digital value in turn, and sequentially supplies digital values K₁ through K₁₀ corresponding to m₁ through m₁₀ to the shift register 31. The shift register 31 stores a series of the input digital values (S1208).

The shift register 31 sequentially supplies the stored digital values (K₁ through K₁₀) to the learning controller 33 on the basis of the clock fed from the variable timing generator 32. The learning controller 33 receives the K₁ through K₁₀ as the digital values obtained at timings m₁ through m₁₀ (S1301).

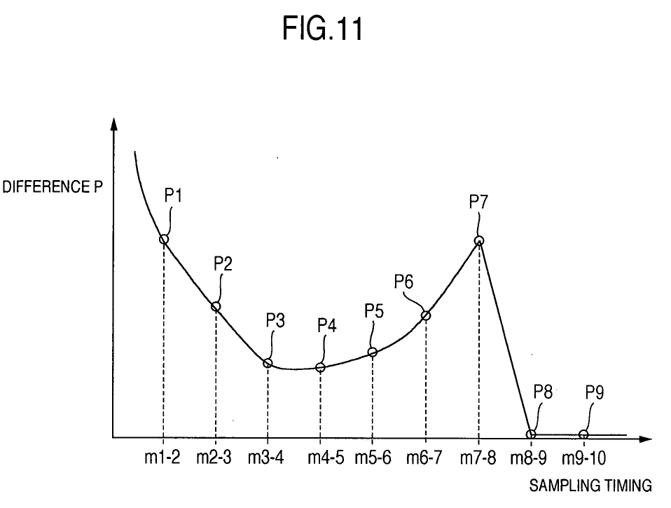

FIG. 10 shows the digital values K₁ through K₁₀ received by the learning controller 33. The learning controller 33 computes differences P₁ through P₉ shown in FIG. 11 by substituting the values of K₁ through K₁₀ into the following equation (3) (S1302).
Pₙ=|Kₙ−K₍ₙ₊₁₎| (3)

The way to find the optimum timing will now be described. First, of the received digital values K₁ through K₁₀, values K larger than the threshold shown in FIG. 10 are selected. The threshold is used to indicate that the received light-based electric signal is the NRZ recording signal. In this embodiment, it is assumed that, when the digital value K is larger than the threshold, the received light-based electric signal is the NRZ signal that is being recorded. Thus, K₁ through K₇ are selected in this way. In addition, differences P₃ and P₄ around the minimal value of the curve shown in FIG. 11 are selected from the P₁ through P₇ corresponding to these values of K (S1303). Thus, the timings m₃ through m₅ corresponding to P₃ and P₄ can be selected as the candidates for the optimum timing (S1304). When the optimum timing includes a plurality of candidates as in this embodiment, the midpoint between those timings of the candidates is selected as the result of the learning, and hence the optimum timing in this embodiment is m₄ (S1305).

Then, the learning controller 33 sets the sample-and-hold timing m₄ in the variable timing generator 32. The variable timing generator 32 sets m₄ in the sample-and-hold timing N to the sample-and-hold device 9 (S1306). Thus, the general controller 16 is directed to indicate the learning result and end and to change the operation mode from the learning operation to the normal operation (S1307).

While the estimated timing Nₛ is supplied as the sample-and-hold timing to the sample-and-hold device 9 in this embodiment, an arbitrary timing may be set.

In this embodiment, as described above, by making this timing learning operation during the trial writing even under the operating speed for which the preset timing value is unknown, it is possible to cope with the change of the optimum timing due to the individual difference, temperature change and change with time. Even when the learning method according to this embodiment is used, the above effects (1) through (5) can be achieved as in the embodiments 1 and 2.

The effects achieved by the construction of this embodiment shown in FIG. 8 are summarized as follows.

In the construction of this embodiment, since the sampling and holding operations in the optical disk drive are performed on the basis of clocks, controlling the clocks will make it possible to achieve the particular effect that the sample-and-hold intervals and the number of samples can be freely set.

In the construction of this embodiment, although the sample-and-hold operation can be made at a plurality of timings when the NRZ signal is recorded once as in the embodiment 2, only the sample-and-hold device included in the analog-to-digital converter 30 is sufficient for the learning operation. That is, the circuit scale can be reduced as compared to the optical disk drive of embodiment 2, and it is also possible to achieve the particular effect that the reliability of the held signals in a plurality of sample-and-hold devices used could be prevented from being degraded due to the inevitable irregular precisions of those sample-and-hold circuits.

According to the construction of this embodiment, the learning operation can be similarly performed without influence on the servo control and wobble detection as in the embodiment 2. Therefore, even under the learning control, normal servo control and wobble detection can be continued.

In the construction of this embodiment, although a high-speed analog-to-digital converter is desired to use, a high-resolution one is not necessary. This is because there is no need to consider the peaks and lower-level portion of the received light-based electric signal. Therefore, relative inexpressive components can be used.

The servo control 11 mentioned in this embodiment makes focus control and tracking control. At this time, since the focus control and tracking control respectively employ different methods of computation, it is necessary to use two different preamplifier-output signals obtained after the amplification of and computation on the received light-based electric signal. Also, while the servo control 11 and wobble detector 17 share the same output from the sample-and-hold device 10 in this embodiment, they may use separate output signals. In other words, a single preamplifier-output signal for wobble detection can be used in addition to the preamplifier-output signals for the servo control and tracking control. The same method for the computation on the received light-based electric signal may be used for the tracking control and wobble control.

In this case, it is necessary to provide a plurality of state detectors. For this purpose, the sample-and-hold device 9 and variable timing generator 32 are provided for each preamplifier-output signal, and a changeover switch is added to use when each preamplifier-output signal is supplied to the analog-to-digital converter 30 so that the preamplifier-output signals can share the analog-to-digital converter 30, shift register 31 and learning controller 33.

In addition, since the three different preamplifier-output signals for the focus control, tracking control and wobble detection are obtained substantially at the same time, the sample-and-hold devices that sample and hold these preamplifier-output signals may perform their operations at the same timing.

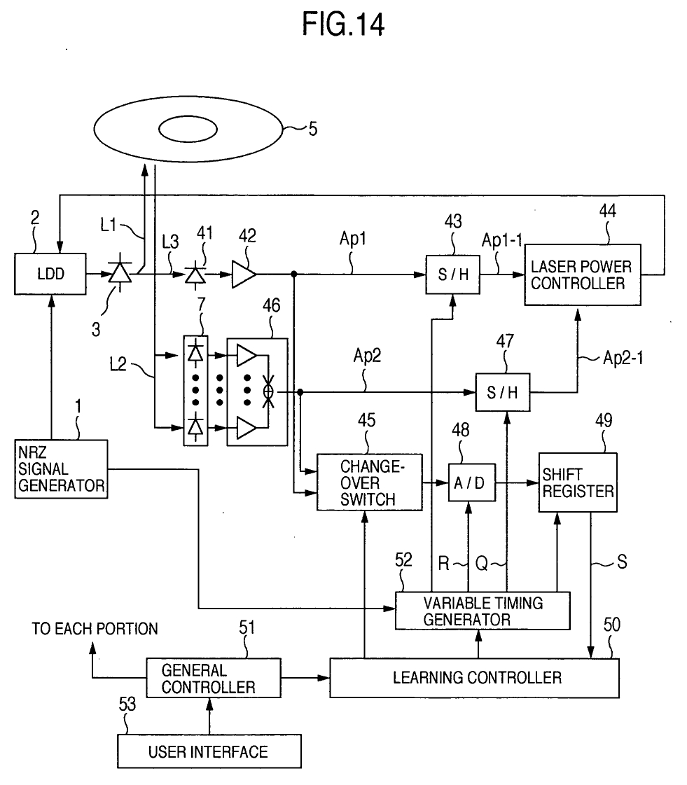

FIG. 14 shows the construction of the optical disk drive of an embodiment 4. In FIG. 14, like elements corresponding to those in the optical disk drive of embodiment 1 are identified by the same reference numerals, and will not be described. The optical disk drive of this embodiment has newly a light-sensitive receiver 41 for receiving branch light L3 of exit light L1, a preamplifier 42 that amplifies the received electric signal of the branch light and makes proper computation on the signal, a sample-and-hold device 43 that samples and holds the preamplifier-output signal Ap1, a laser power controller 44 that controls the laser power on the basis of the input sampled and held result, a preamplifier 46 that amplifies the received electric signals of the reflected light and makes appropriate computation on these signals, a sample-and-hold device 47 that samples and holds the preamplifier-output signal Ap2, a changeover switch 45 that switches the two received electric signals, an analog-to-digital converter (A/D) 48, a shift register 49, a variable timing generator 52, and a learning controller 50.

Here, since the preamplifier-output signal Ap1 based on the branch light L3, and preamplifier-output signal Ap2 of reflected light L2 are different in their waveforms and timings, the sample-and-hold timing to the sample-and-hold device 43 that produces output of Ap1-1 is separated from the timing to the sample-and-hold device 47 so that it can be used for the learning operation and setting.

The optical disk drive of this embodiment controls laser power.

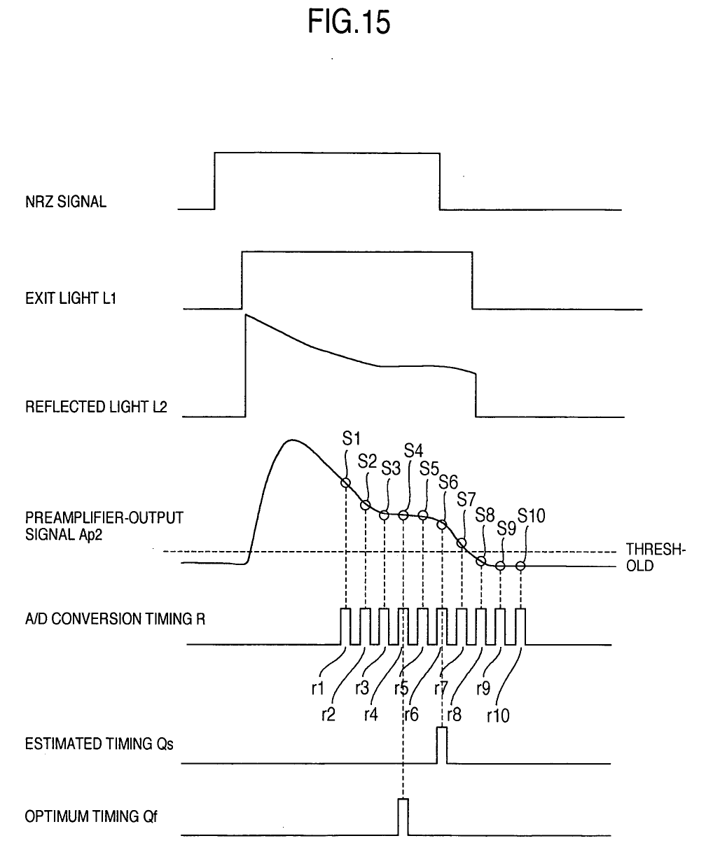

Description will be made of the learning operation using the preamplifier-output signal Ap2 during the actual operation, thereby optimizing the sample-and-hold timing in the optical disk drive of this embodiment. It is now assumed that, in this embodiment, the learning operation is performed during the trial writing operation, thereby optimizing the sample-and-hold timing, and then the actual operation is started. The sample-and-hold timing is changed with time so that the optimum timing (Qₛ) obtained during the trial writing operation becomes different from the true optimum timing (Q_{f}) obtained during the actual operation as shown in FIG. 15. Since the timing Qₛ is different from the optimum timing during the actual operation, this timing Qₛ is, here, called an estimated timing.

The processes for the learning operation will be sequentially described with reference to FIGS. 14 and 15.

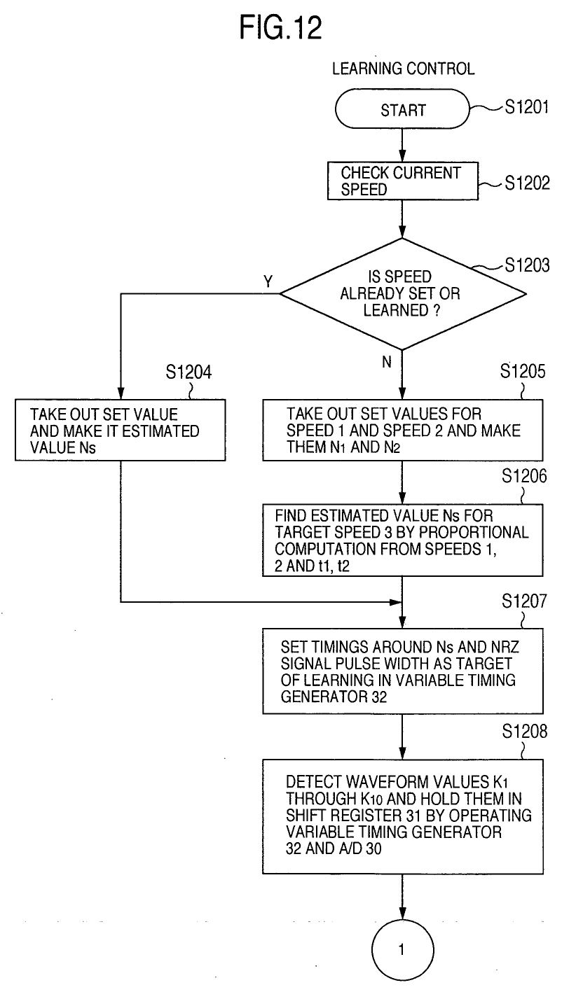

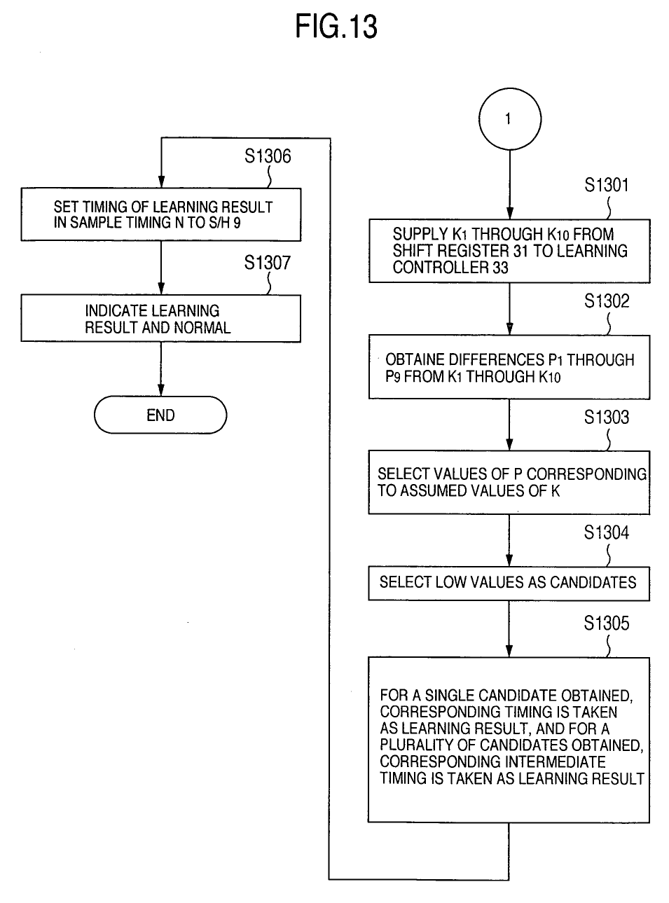

The operation of the learning controller 50 given below is made according to the flowcharts shown in FIGS. 12 and 13. Although the reference numerals are necessary to change when the processes of the operation in this embodiment will be described with reference to FIGS. 12 and 13, the processes are the same as in the embodiment 3, and the same algorithm can be used even if the situations are different. At this time, the reference numerals are changed as follows. The variable timing generator 32 is changed to the variable timing generator 52, A/D 30 to A/D 48, waveform values K₁ through K₁₀ to waveform values S₁ through S₁₀, shift register 31 to shift register 49, learning controller 33 to learning controller 50, and S/H 9 to S/H 47.

First, the learning controller 50 supplies the estimated timing Qₛ computed during the trial writing to the variable timing generator 52. The variable timing generator 52 causes the sample-and-hold device 47 to be configured to produce the estimated timing Qₛ as a sample-and-hold timing C3 (S1204). Thus, a tentative operating precision can be assured by using the estimated timing Qₛ even before the optimization.

Then, the learning controller 50, after confirming that the estimated timing Qₛ is set in the variable timing generator 52, forces the changeover switch 45 to select the preamplifier-output signal Ap2, and fixes the pulse width of NRZ to a value as the target for making the learning operation (S1207). Here, the NRZ pulse-width is selected to be 4 T, or the same as in the embodiments 1 through 3.

Further, the learning controller 50 sets timings r₁ through r₁₀ including the estimated timing Qₛ as sample-and-hold timings as shown in FIG. 15 (S1207).

The variable timing generator 52, when detecting the NRZ recording pulse of 4-T width, generates timing pulses at timings r₁ through r₁₀ at which the analog-to-digital converter 48 makes the analog-to-digital conversion along timing R. The analog-to-digital converter 48 converts the preamplifier-output signal Ap2 at each of pulses r₁ through r₁₀ from the analog to digital form in turn, and sequentially supplies the digital values S₁ through S₁₀ corresponding to r₁ through r₁₀ to the shift register 49. The shift register 49 stores a series of input digital values (S1208).

The shift register 49 sequentially supplies the stored digital values (S₁ through S₁₀) to the learning controller 50 on the basis of the clock fed from the variable generator 52. The learning controller 50 sequentially stores the digital values S₁ through S₁₀ corresponding to the timing r₁ through r₁₀ (S1301).

FIG. 15 shows the digital values S₁ through S₁₀ taken in by the learning controller 50. The learning controller 50 computes differences P₁ through P₉ by substituting S₁ through S₁₀ into the following equation (4) (S1302).
Pₙ=|Sₙ−S₍ₙ₊₁₎| (4)

Here, the way to find the optimum timing in this embodiment is the same as described with reference to FIGS. 10 and 11 of the embodiment 3, and will not be described. According to this embodiment, the true optimum timing can be obtained as r₄ (S1303 through S1305). The way to find the optimum timing in this embodiment is implemented with FIG. 10 of embodiment 3 changed to FIG. 15, and with digital values K changed to digital values S.

Thereafter, the learning controller 50 sets sample timing r₄ in the variable timing generator 52. The variable timing generator 52 sets r₄ in the sample timing Q of the sample-and-hold device 47 (S1306). Thus, the general controller 51 is directed to indicate the learning result and end and to change the operation mode from the learning operation to the normal operation (S1307).

The learning operation to the preamplifier-output signal Ap1 can be performed after selecting the preamplifier-output signal Ap1 by the changeover switch 45 and then making the same operations as above. At this time, the sample-and-hold device 47 is used instead of the sample-and-hold device 43.

While the estimated timing Qₛ is set in the sample-and-hold device 43 or 47 as a sample-and-hold timing in this embodiment, an arbitrary timing may be set.

According to this embodiment, as described above, since this timing learning operation is carried out during the actual operation, the optimum timing can be obtained by periodically or irregularly repeating the learning in order to cope with the deviation of the optimum timing away from the true optimum timing due to the change of temperature and power supply voltage during the actual operation even if the disk is driven at the operating speed based on the optimum timing that is previously obtained by this learning. In this case, also according to the learning method of this embodiment, the above effects (1) through (5) can be similarly achieved as in the embodiments 1 through 3.

In addition, the effects that can be achieved by the construction of this embodiment shown in FIG. 14 are summarized as follows.

According to the construction of this embodiment, since the timing to the sample-and-hold device 47 that produces the main line signal is not necessary to change as in the embodiment 2 or 3, there is the advantage that, even if the learning operation is made during the actual operation, the laser power can be controlled without any influence by that operation.

According to the construction of this embodiment, although the sample-and-hold operation can be performed at a plurality of timings during the time when the NRZ signal is recorded once as in the embodiment 2 or 3, the sample-and-hold device that is necessary and sufficient for the learning operation is only a single one included in the analog-to-digital converter 43 or 47. Therefore, the construction of this embodiment also could avoid the reliability of the hold signal from being degraded by the irregular precisions of the sample-and-hold circuits.

According to the construction of this embodiment, the analog-to-digital converter used is desired to operate fast as in the embodiment 3, but does not need high resolution. Therefore, relatively inexpensive components can be used.

While the optical disk drive makes servo control such as focus and tracking control, and detects wobble in the embodiments 1 through 3, it may control the laser power. While the optical disk drive controls laser power in this embodiment, it may make servo control such as focus control and tracking control, and wobble detection.

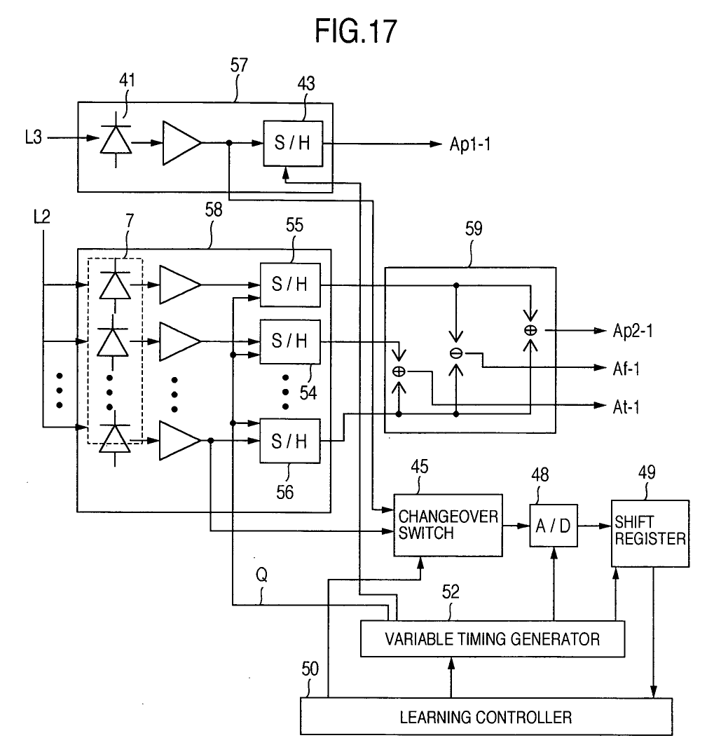

A modification of part of the construction of the embodiment shown in FIG. 14 will be described with reference to FIG. 17. FIG. 17 is a block diagram of part of the modification of the construction shown in FIG. 14. In FIG. 17, like elements corresponding to those in FIG. 14 are identified by the same reference numerals, and will not be described. The construction shown in FIG. 17 has newly sample-and-hold devices 54 through 56, and a collective arithmetic unit 59. Since the preamplifier-output signal Ap1 based on the branch light L3 and the preamplifier-output signal Ap2 based on the reflected light L2 are different in waveforms and timings, the sample-and-hold timing to the sample-and-hold device 43 that produces the preamplifier-output signal Ap1-1 is separated from that to the sample-and-hold devices 54 through 56 so that the learning operation and setting can be performed separately.

In the construction shown in FIG. 14, the preamplifier-output signal Ap2 of the reflected light L2 for the learning operation was produced by amplifying the output signals from the photo acceptance units of the light-sensitive receiver 7 and by computation on those signals. However, in the construction shown in FIG. 17, since the output signals from the photo acceptance units of the light-sensitive receiver 7 are amplified and fed to the sample-and-hold devices, respectively before being subjected to that computation, multiple control signals can be obtained by a single learning operation.

That is, in the construction shown in FIG. 17, the multiple control signals Ap2-1, Af-1 and At-1 produced from the collective arithmetic unit 59 by making different kinds of computations on the outputs from the sample-and-hold devices may be used as, for example, the laser power control signal, focus control signal, tracking control signal and wobble detection signal based on the reflected light.

The signals Ap2-1 and Af-1 that are produced by different computations share the sample-and-hold devices. Therefore, the same sample-and-hold timing Q can be used to the devices.

Thus, the construction shown in FIG. 17 has the advantage that multiple control signals can be obtained by a single learning operation, and further has the following features.

First, it has the advantage that the circuits-packaging area can be reduced so that the drive can be miniaturized. This is because three groups of the photo acceptance units, the preamplifiers and the sample-and-hold devices can be integrally packaged to form integrated circuits 57 and 58. In addition, since the sample-and-hold devices are incorporated in those integrated circuits, the individual differences between the sample-and-hold devices themselves can be reduced so that the sampling precision can be prevented from being lowered.

Moreover, since the outputs from the sample-and-hold devices 54 through 56 result from holding the sampled preamplifier-output signal values for a certain time, the frequency band is low, and thus the packages of the circuits can be simplified.

The effects common to the embodiments 1 through 4 mentioned above, and the conditions common to the learning operations will be described below.
(a) By repeating a plurality of times the learning operation mentioned in each embodiment and considering the results, it is possible to determine the optimum timing with highest accuracy.
(b) While the width of the NRZ signal recording pulse for learning is selected to be 4 T that appears frequently when it is recorded according to DVD standards in each embodiment, the NRZ signal recording pulse may have possible widths of 3 T through 14 T, and thus an arbitrary width can be used without limiting to that value in this invention.
(c) While the range of sample-and-hold timings at the time of learning is fixed to 1-T width including the preset timing value in each embodiment, an arbitrary range of timings can be selected without limiting to that range in this invention.
(d) While the number of sample-and-hold timings at the time of learning is a pattern of five of B₁ through B₅ in embodiment 1, a pattern of five of T₁ through T₅ in embodiment 2, a pattern of ten of m₁ through m₁₀, and a pattern of ten of r₁ through r₁₀, an arbitrary number of timings can be selected without limiting to that number in this invention.
(e) The learning operation can be carried out periodically or irregularly during the actual operation in each embodiment.
(f) While the operation timing is uniquely changed to the result of the learning when the user orders the learning operation about timing to be made irregularly in each embodiment, the timing is not necessary to change, but the user may be notified of only whether the setting should be changed or not. In this case, the user is desirably able to instruct the drive to change the sample-and-hold timing. The user interface used here may be the operation display, keyboard and mouse of a computer that will be connected. When the drive is incorporated in a dedicated device such as a home DVD recorder, a state indicator and a push button may be provided as the user interface on the front operation panel of this device. The reference numeral 53 in FIGS. 1, 5 and 14 represents the user interface.
(g) The servo control signal and wobble detection signal in the embodiments 1 through 3 are produced by the sample-and-hold operation using the learning result, and the laser power control signal in the embodiment 4 is produced by that operation. However, even in each of the embodiments, either one or ones of the servo control signal, wobble detection signal and laser power control signal may be produced by the sample-and-hold operation using the learning result.
(h) While each range of the sample-and-hold timings B₁ through B₅ in the embodiment 1, the timings T₁ through T₅ in the embodiment 2, the timings m₁ through m₁₀ in the embodiment 3, and the timings r₁ through r₁₀ in the embodiment 4 is set to include the preset timing value or estimated timing, timings may be selected from an arbitrary range of sample-and-hold timings without limiting to these ranges even in each of the embodiments.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications within the ambit of the appended claims.

1. An optical disk drive comprising:
a laser for emitting laser light to an optical disk so that prescribed data can be recorded on said disk;
a light-sensitive receiver for receiving reflected light from said optical disk;
first sample-and-hold unit capable of sampling and holding the output signal from said light-sensitive receiver;
second sample-and-hold unit capable of sampling and holding the output signal from said first sample-and-hold means;
variable timing unit for setting a certain timing selected from a plurality of candidates as a sample-and-hold timing for said first sample-and-hold unit;
hold control unit for updating said sample-and-hold timing for said first sample-and-hold unit or second sample-and-hold unit; and
control unit having a function to select a plurality of timings as candidates of sample-and-hold timing from an arbitrary range of timings and to transmit said plurality of timings to said variable timing unit, and a function to transmit a selected timing from said plurality of timings to said hold control unit.

2. An optical disk drive according to claim 1, wherein said control unit
sets a plurality of sample-and-hold timings B₁ through Bₙ (n: natural numbers equal to and larger than 2),
sets said plurality of timings in said variable timing unit in turn,
computes differences E₁ through Eₙ₋₁ by using the following equation (1) and output signal values D₁ through Dₙ that said first sample-and-hold unit has produced by sampling and holding the output signal from said light-sensitive receiver according to each of said timings,
Eₙ₋₁=|Dₙ−D₍ₙ₊₁₎| (1), and
selects a timing corresponding to the minimum difference of said differences E₁ through Eₙ₋₁ as a timing to be set in said hold control unit.

3. An optical disk drive comprising:
a laser for emitting laser light to an optical disk so that prescribed data can be recorded on said disk;
a light-sensitive receiver for receiving reflected light from said optical disk;
first sample-and-hold unit capable of sampling and holding the output signal from said light-sensitive receiver;
a plurality of sample-and-hold units capable of sampling and holding the output signal from said light-sensitive receiver and disposed in parallel with said first sample-and-hold unit;
variable timing unit for setting timings selected from a plurality of candidates of timings as sample-and-hold timings for said first sample-and-hold unit and for said plurality of sample-and-hold units disposed in parallel with said first sample-and-hold unit; and
control unit having a function to select a plurality of timings as timing candidates necessary for sample-and-hold operations from an arbitrary range of timings and to transmit them to said variable timing unit, and a function to control said variable timing unit so that one of said plurality of timings can be updated as the sample-and-hold timing to said first sample-and-hold unit.

4. An optical disk drive according to claim 3, wherein said control unit
sets a plurality of sample-and-hold timings B₁ through Bₙ (n: natural numbers equal to or larger than 2),
sets said plurality of timings in said variable timing unit,
computes differences E₁ through Eₙ₋₁ by using the following equation (1) and output signal values D₁ through Dₙ that said first sample-and-hold unit and plurality of sample-and-hold unit disposed in parallel with said first sample-and-hold unit have produced by sampling and holding the output signal from said light-sensitive receiver according to any of said plurality of timings B₁ through Bₙ,
Eₙ₋₁=|Dₙ−D₍ₙ₊₁₎| (1), and
selects a timing corresponding to the minimum difference of said differences E₁ through Eₙ₋₁ as a timing to be set in said first sample-and-hold unit.

5. An optical disk drive according to claim 4, wherein in case a default preset timing value to sample-and-hold the output signal from said light-sensitive receiver exists said variable timing unit sets said default preset timing value in said first sample-and-hold unit, said sample-and-hold timings except said default preset timing value in said plurality of sample-and-hold units disposed in parallel with said first sample-and-hold unit, and selects said timing Bₙ or Bₙ₊₁ corresponding to the minimum of Eₙ as a timing to said first sample-and-hold unit.

6. An optical disk drive comprising:
a laser for emitting laser light to an optical disk so that prescribed data can be recorded on said disk;
a first light-sensitive receiver for receiving reflected light from said optical disk;
first sample-and-hold unit capable of sampling and holding the output signal from said light-sensitive receiver;
analog-to-digital (A/D) converter for converting said output signal from said light-sensitive receiver to a digital form on the basis of an inputted clock signal;
a shift register capable of storing the output signal from said A/D converter on the basis of said inputted clock signal;
variable timing generator for supplying a prescribed number of input clock signals to said A/D converter and said shift register; and
control unit for controlling said first sample-and-hold unit so that the timing corresponding to one of the clock signals supplied from said variable timing generator can be updated to be a sample-and-hold timing to said first sample-and-hold unit.

7. An optical disk drive according to claim 6, wherein said control unit
sets a plurality of sample-and-hold timings B₁ through Bₙ (n: natural numbers equal to or larger than 2),
sets said plurality of timings in said variable timing unit so that said timings can be supplied as clock signals to said A/D converter and said shift register,
computes differences E₁ through Eₙ₋₁ by using the following equation (1) and digital values D₁ through Dₙ that said A/D converter and then said shift register have produced by processing the output signal from said light-sensitive receiver according to their functions,
Eₙ₋₁=|Dₙ−D₍ₙ₊₁₎| (1), and
selects a timing corresponding to the minimum difference from said differences E₁ through Eₙ₋₁ as a timing to be set in said first sample-and-hold unit.

8. An optical disk drive according to claim 6, further comprising:
a second light-sensitive receiver for receiving the emitted light from said laser;
second sample-and-hold unit capable of sampling and holding the output signal from said second light-sensitive receiver; and
switching unit for switching said output signals from said first light-sensitive receiver and second light-sensitive receiver and transmitting the selected one to said A/D converter unit.

9. An optical disk drive according to claim 8, wherein said control unit
sets a plurality of sample-and-hold timings B₁ through Bₙ (n: natural numbers equal to or larger than 2);
sets said plurality of timings in said variable timing unit so that said timings can be supplied as clock signals to said A/D converter and said shift register;
computes differences E₁ through Eₙ₋₁ by using the following equation (1) and digital values D₁ through Dₙ that said A/D converter and then said shift register have produced by processing the output signal from said first or second light-sensitive receiver according to their functions, and
Eₙ₋₁=|Dₙ−D₍ₙ₊₁₎| (1), and
selects a timing corresponding to the minimum difference of said differences E₁ through Eₙ₋₁ as a timing to be set in said first or second sample-and-hold unit.

10. An optical disk drive according to claim 8, wherein
said first light-sensitive receiver is a four-element light-sensitive receiver formed of four photo acceptance units,
four sample-and-hold units are provided to be capable of sampling and holding each of four output signals from said four-element light-sensitive receiver, and
computing unit is provided to be capable of making a plurality of different calculating operations by using the four different values produced from said four sample-and-hold units.

11. An optical disk drive according to claim 10, wherein said control unit
sets a plurality of sample-and-hold timings B₁ through Bₙ (n: natural numbers equal to or larger than 2),
sets said plurality of timings in said variable timing unit so that said timings can be supplied as clock signals to said A/D converter and said shift register,
computes differences E₁ through Eₙ₋₁ by using the following equation (1) and digital values D₁ through Dₙ that said A/D converter and then said shift register have produced by processing one of the output signals from said four-element light-sensitive receiver or the output signal from said second light-sensitive unit according to their functions,
Eₙ₋₁=|Dₙ−D₍ₙ₊₁₎| (1), and
selects a timing corresponding to the minimum difference of said differences E₁ through Eₙ₋₁ as a timing to be set in said four sample-and-hold unit or said second sample-and-hold unit.

12. An optical disk drive according to claim 2, wherein
a default preset timing value is provided to use in sampling and holding the output signal from said light-sensitive receiver,
said default preset timing value is derived by substituting an arbitrary operating speed into x of the following equation (2) that is based on timing values for a plurality of certain already-known operating speeds and on said operating speeds,
y=−Ax+B (2), and
said plurality of sample-and-hold timings B₁ through Bₙ (n: natural numbers equal to or larger than 2) are set to include said default preset timing value.

13. An optical disk drive according to claim 2, wherein
a threshold is provided to judge which one or ones of the output signal values from said light-sensitive receiver, or of said digital values D₁ through Dₙ are produced during the time in which an NRZ signal is being recorded, and
said control unit
judges, on the basis of said threshold, which one or ones of the output signal values from said light-sensitive receiver, or of said digital values D₁ through Dₙ are produced during the time in which said NRZ signal, and selects said corresponding one or ones of said values,
substitutes said selected one or ones of said output signals, or of said digital values into said equation (1) so that said differences E₁ through Eₙ can be calculated from said equation, and
selects a timing corresponding to the minimum difference from said differences E₁ through Eₙ as a timing to be set in said hold control means or said first or second sample-and-hold unit.

14. An optical disk drive according to claim 2, wherein
in case a timing corresponding to the minimum difference of said differences E₁ through Eₙ cannot be selected, a plurality of timings around said minimum difference are selected, and the intermediate value of said plurality of timings is selected as a timing to be set in said hold control unit or said first or second sample-and-hold unit.

15. An optical disk drive according to claim 2, wherein
a servo control signal or wobble detection signal is obtained by using the results of the sampling and holding operation of said hold control unit, said first or second sample-and-hold unit or said four sample-and-hold units capable of sampling and holding the four different output signals derived from said four-element light-sensitive receiver.

16. An optical disk drive according to claim 9, wherein
a laser power control signal is obtained by using the results of the sampling and holding operation of said four sample-and-hold units capable of sampling and holding the four different output signals from said four-element light-sensitive receiver or of said second sample-and-hold unit.

17. An optical disk drive according to claim 2, wherein
when a learning operation is performed periodically or irregularly, or instructed to perform by the user during a trial writing time before recording information on an optical disk or during the actual writing, a timing is derived to be set in said control means or said first or second sample-and-hold means.

18. A sampling-and-holding apparatus comprising:
a laser for emitting laser light to an optical disk so that prescribed data can be recorded on said optical disk;
a first light-sensitive receiver for receiving reflected light from said optical disk or a second light-sensitive receiver for receiving the light emitted from said laser; and
first or second sample-and-hold unit capable of sampling and holding the output signal from said first or second light-sensitive receiver, wherein
when the recording speed of said optical disk is changed from a first recording speed to a second recording speed (the second recording speed is 2.5 times faster than said first recording speed) during the time in which data is being recorded on said optical disk, the output signal from said first or second light-sensitive receiver is sampled and held with a timing at which the output signal from said first or second light-sensitive receiver is little changed even at either one of said recording speeds.

19. A sampling-and-holding apparatus comprising:
a pickup including a laser for emitting laser light to an optical disk so that prescribed data can be recorded on said optical disk, an object lens for controlling the irradiated light from said laser and a first light-sensitive receiver for receiving the reflected light from said optical disk or a second light-sensitive receiver for receiving the irradiated light from said laser; and
first or second sample-and-hold unit capable of sampling and holding the output signal from said first or second light-sensitive receiver, wherein
when the ambient temperature of said pickup is changed from a first temperature to a second temperature (the second temperature is 20 to 30 degrees higher than the first temperature) when data is being recorded on said optical disk, the output signal from said first or second light-sensitive receiver is sampled and held with a timing at which the output signal from said first or second light-sensitive receiver is little changed even at either temperature of said first and second temperatures.

20. An optical disk drive according to claim 12, wherein
when data is being recorded on said optical disk and when a plurality of sample-and-hold unit disposed in parallel with said first sample-and-hold unit, or said A/D converter unit samples and holds with a plurality of sample-and-hold timings, said first sample-and-hold unit continues to hold the sampled and held value resulting from sampling and holding the output signal from said light-sensitive receiver at said default preset timing value.
